(19) United States
(12) Patent Application Publication
(10) Pub. No.: US 2026/0024087 A1
(43) Pub. Date: Jan. 22, 2026

(54) METHOD AND SYSTEM FOR DETECTING AND ENFORCING AGAINST SANCTIONABLE EVENT USING BLOCKCHAIN TECHNOLOGY

(71) Applicant: MASTERCARD INTERNATIONAL INCORPORATED, Purchase, NY (US)

(72) Inventors: Jaipal Singh KUMAWAT, Sikar, Rajasthan (IN); Shivendra Pratap SINGH, Sultanpur (IN); Ojaswi KUMAR, Varanasi (IN)

(73) Assignee: MASTERCARD INTERNATIONAL INCORPORATED, Purchase, NY (US)

(21) Appl. No.: 19/116,455

(22) PCT Filed: Sep. 25, 2023
(86) PCT No.: PCT/US2023/033596

§ 371 Date: Mar. 28, 2025

(30) Foreign Application Priority Data
Sep. 30, 2022 (IN) 202241056456

(51) Int. Cl. G06Q 20/40; G06Q 20/38

(52) U.S. Cl. CPC G06Q 20/4015; G06Q 20/389

(57) ABSTRACT

Methods and systems for preventing geographically unauthorized blockchain transactions are discussed herein. Participants in a blockchain provide information during an onboarding process to identify a geographic location associated therewith. During the onboard, a geographic key is assigned to the participant based on their geographic location. When a new proposed blockchain transaction is submitted, the geographic keys associated with the participants are identified. If the geographic keys match, which indicates that the participants are associated with the same geographic location, then the transaction is authorized and goes through a standard blockchain approval process. If the geographic keys do not match, indicating that the participants are in different geographic locations, then a check is performed to determine if the transaction can proceed using a smart contract, which determines if there are any sanctions or other regulations preventing the transaction from taking place between the participants in the associated geographic locations.

### CROSS REFERENCE TO RELATED APPLICATION

This application claims the benefit of Indian patent application Ser. No. 20/224,1056456, which was filed on Sep. 30, 2022, the entire contents of which are hereby incorporated by reference for all purposes.

### FIELD

The present disclosure relates to the mitigation of geographically unauthorized blockchain transactions, such as the applicability of issued sanctions to blockchain transactions.

### BACKGROUND

Blockchains were first created as a way of providing for a cryptographic currency that could be transferred among participants in a decentralized manner that provided the participants with anonymity. While every transaction was recorded on the blockchain including the source and destination addresses, no information was required to be stored in the blockchain or available to tie either address to a specific user, let alone provide any further information about that user. This was and is an attractive benefit to the use of blockchain for transactions that, combined with the ease at which it could be implemented, has resulted in the creation of hundreds of different cryptographic currencies, each managed using their own individual blockchain.

However, the decentralized and anonymous nature of blockchains also results in significant difficulty in preventing unauthorized transactions. For instance, one or more country's government(s) can be interested in establishing sanctions against another country, one of which can include preventing payment transactions involving participants in the other country. For traditional electronic payment transactions, such as using credit cards or debit cards, such sanctions can be easily implemented as the physical location of both participants are identified during the processing of the transaction. However, because participants in a blockchain are commonly anonymous and no information obtained on the participants beyond data pertaining to each blockchain wallet, there are currently no technology based methods for applying sanctions to blockchain transactions.

Thus, there is a need for a technological improvement to blockchains and the processing of blockchain transactions to enable the prevention of transactions that are geographically unauthorized.

### SUMMARY

The present disclosure provides a description of systems and methods for preventing geographically unauthorized blockchain transactions. Participants in a blockchain provide information during an onboarding process to identify a geographic location associated therewith. During the onboarding process of a participant, a geographic key is assigned to the participant based on the identified geographic location. When a new proposed blockchain transaction is submitted, the geographic key associated with the sending and receiving participants is identified. If the geographic keys match, which indicates that the participants are associated with the same geographic location, then the transaction is authorized, and then goes through a standard blockchain approval process. If the geographic keys do not match, indicating that the participants are in different geographic locations, then a check is performed using a smart contract to determine if the transaction can proceed without violating sanctions. The check is used to determine if there are any sanctions or other regulations preventing the transaction from taking place between the participants in the associated geographic locations. In some embodiments, each geographic location can have a separate blockchain associated therewith, where, in some cases, a core blockchain can be utilized to store geographic keys and other data of all the separate blockchains.

A method for preventing geographically unauthorized blockchain transactions includes: receiving, by a receiver of a processing server, transaction data for a proposed blockchain transaction from an external computing system, the transaction data including at least a source address and a destination address; identifying, by a processor of the processing server, a source geographic key associated with a first geographic location based on at least the source address and a destination geographic key associated with a second geographic location based on at least the destination address; determining, by the processor of the processing server, if the source geographic key is equivalent to the destination geographic key; if the processor determines that the source geographic key is equivalent to the destination geographic key, initiating, by the processor of the processing server, a new blockchain transaction on a first blockchain associated with the source geographic key based on at least the transaction data; if the processor determines that the source geographic key is not equivalent to the destination geographic key, executing, by the processor of the processing server, a smart contract using at least the source geographic key and the destination geographic key as input, wherein the smart contract outputs a validation for the proposed blockchain transaction; if the validation for the proposed blockchain transaction is a negative validation, transmitting, by a transmitter of the processing server, a decline message for the proposed blockchain transaction to the external computing system; and if the validation for the proposed blockchain transaction is a positive validation, initiating, by the processor of the processing server, a first blockchain transaction on the first blockchain associated with the source geographic key based on at least the transaction data, and initiating, by the processor of the processing server, a second blockchain transaction on a second blockchain associated with the destination geographic key based on at least the transaction data.

A system for preventing geographically unauthorized blockchain transactions includes: an external computing system; and a processing server, the processing server including a receiver receiving transaction data for a proposed blockchain transaction from the external computing system, the transaction data including at least a source address and a destination address, a processor, the processor identifying a source geographic key associated with a first geographic location based on at least the source address and a destination geographic key associated with a second geographic location based on at least the destination address, and determining if the source geographic key is equivalent to the destination geographic key, and a transmitter, wherein if the processor of the processing server determines that the source geographic key is equivalent to the destination geographic key, initiating, by the processor of the processing server, a new blockchain transaction on a first blockchain associated with the source geographic key based on at least the transaction data, if the processor determines that the source geographic key is not equivalent to the destination geographic key, the processor of the processing server executes a smart contract using at least the source geographic key and the destination geographic key as input, wherein the smart contract outputs a validation for the proposed blockchain transaction; if the validation for the proposed blockchain transaction is a negative validation, the transmitter of the processing server transmits a decline message for the proposed blockchain transaction to the external computing system, and if the validation for the proposed blockchain transaction is a positive validation, the processor of the processing server initiates a first blockchain transaction on the first blockchain associated with the source geographic key based on at least the transaction data, and the processor of the processing server initiates a second blockchain transaction on a second blockchain associated with the destination geographic key based on at least the transaction data.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high-level system architecture for preventing geographically unauthorized blockchain transactions in accordance with exemplary embodiments.

FIG. 2 is a block diagram illustrating the processing server in the system of FIG. 1 for preventing geographically unauthorized blockchain transactions in accordance with exemplary embodiments.

FIG. 3 is a flow diagram illustrating a process for preventing geographically unauthorized blockchain transactions as performed by the processing server of FIG. 2 in accordance with exemplary embodiments.

FIG. 4 is a flow chart illustrating an exemplary method for preventing geographically unauthorized blockchain transactions in accordance with exemplary embodiments.

FIG. 5 is a block diagram illustrating a computer system architecture in accordance with exemplary embodiments.

Further areas of applicability of the present disclosure will become apparent from the detailed description provided hereinafter. It should be understood that the detailed description of exemplary embodiments is intended for illustration purposes only and are, therefore, not intended to necessarily limit the scope of the disclosure.

### DETAILED DESCRIPTION

### System for Preventing Geographically Unauthorized Blockchain Transactions

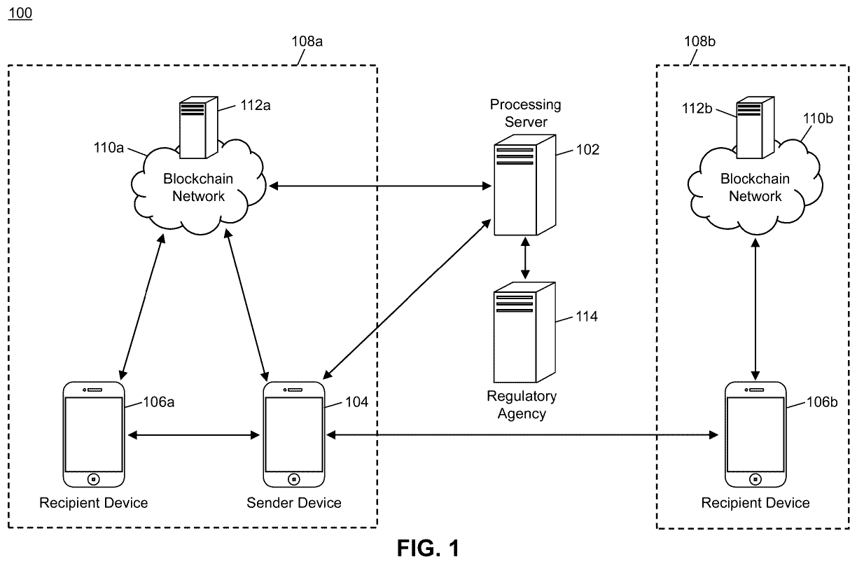

FIG. 1 illustrates a system 100 for the preventing of geographically unauthorized blockchain transactions via the use of geographic keys.

The system 100 can include a processing server 102. The processing server 102, discussed in more detail below, can be configured to participate in the processing of proposed blockchain transactions to prevent unauthorized transactions between participants located in different geographic locations. The system 100 can also include a sender device 104 and recipient devices 106, where each device can have a blockchain wallet stored therein or otherwise associated therewith, as discussed in more detail below. The sender device 104 and recipient devices 106 can be any type of computing device suitable for performing the functions discussed herein, such as a desktop computer, laptop computer, notebook computer, tablet computer, cellular phone, smart phone, smart watch, smart television, wearable computing device, implantable computing device, etc.

The sender device 104 can be located in a first geographic location 108a. The sender device 104 can participant in blockchain transactions with recipient devices 106a located in the same first geographic location 108a as well as recipient devices 106b located in a second geographic location 108b. The geographic locations 108 can be countries, states, provinces, or any other geographically distinct area.

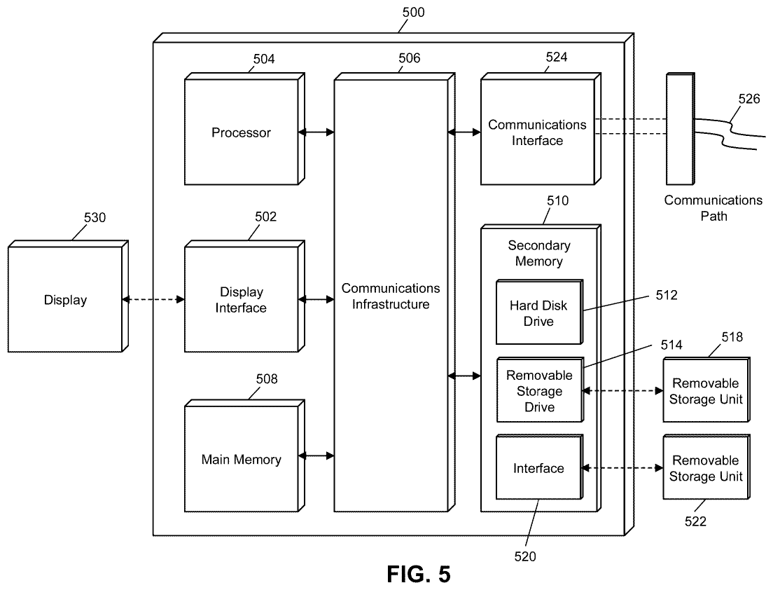

The system 100 can also include blockchain networks 110. In some cases, each geographic location 108 can have its own blockchain network 110 associated therewith, such as blockchain networks 110a and 110b as illustrated in FIG. 1. The blockchain networks 110 can be comprised of a plurality of blockchain nodes 112. Each blockchain node 112 can be a computing system, such as illustrated in FIG. 5, discussed in more detail below, that is configured to perform functions related to the processing and management of the blockchain, including the generation of blockchain data values, verification of proposed blockchain transactions, verification of digital signatures, generation of new blocks, validation of new blocks, and maintenance of a copy of the blockchain.

The blockchain can be a distributed ledger that is comprised of at least a plurality of blocks. Each block can include at least a block header and one or more data values. Each block header can include at least a timestamp, a block reference value, and a data reference value. The timestamp can be a time at which the block header was generated and can be represented using any suitable method (e.g., UNIX timestamp, DateTime, etc.). The block reference value can be a value that references an earlier block (e.g., based on timestamp) in the blockchain. In some embodiments, a block reference value in a block header can be a reference to the block header of the most recently added block prior to the respective block. In an exemplary embodiment, the block reference value can be a hash value generated via the hashing of the block header of the most recently added block. The data reference value can similarly be a reference to the one or more data values stored in the block that includes the block header. In an exemplary embodiment, the data reference value can be a hash value generated via the hashing of the one or more data values. For instance, the block reference value can be the root of a Merkle tree generated using the one or more data values.

The use of the block reference value and data reference value in each block header can result in the blockchain being immutable. Any attempted modification to a data value would require the generation of a new data reference value for that block, which would thereby require the subsequent block's block reference value to be newly generated, further requiring the generation of a new block reference value in every subsequent block. This would have to be performed and updated in every single blockchain node 112 in the blockchain network 110 prior to the generation and addition of a new block to the blockchain in order for the change to be made permanent. Computational and communication limitations can make such a modification exceedingly difficult, if not impossible, thus rendering the blockchain immutable.

In some embodiments, the blockchain can be used to store information regarding blockchain transactions conducted between two different blockchain wallets. A blockchain wallet can include a private key of a cryptographic key pair that is used to generate digital signatures that serve as authorization by a payer for a blockchain transaction, where the digital signature can be verified by the blockchain network 110 using the public key of the cryptographic key pair. In some cases, the term “blockchain wallet” can refer specifically to the private key. In other cases, the term “blockchain wallet” can refer to a computing device (e.g., sender device 104, recipient device 106, etc.) that stores the private key for use thereof in blockchain transactions. For instance, each computing device can each have their own private key for respective cryptographic key pairs and can each be a blockchain wallet for use in transactions with the blockchain associated with the blockchain network. Computing devices can be any type of device suitable to store and utilize a blockchain wallet, such as a desktop computer, laptop computer, notebook computer, tablet computer, cellular phone, smart phone, smart watch, smart television, wearable computing device, implantable computing device, etc.

Each blockchain data value stored in the blockchain can correspond to a blockchain transaction or other storage of data, as applicable. A blockchain transaction can consist of at least: a digital signature of the sender of currency (e.g., a sender device 104) that is generated using the sender's private key, a blockchain address of the recipient of currency (e.g., a recipient device 106) generated using the recipient's public key, and a blockchain currency amount that is transferred or other data being stored. In some blockchain transactions, the transaction can also include one or more blockchain addresses of the sender where blockchain currency is currently stored (e.g., where the digital signature proves their access to such currency), as well as an address generated using the sender's public key for any change that is to be retained by the sender. Addresses to which cryptographic currency has been sent that can be used in future transactions are referred to as “output” addresses, as each address was previously used to capture output of a prior blockchain transaction, also referred to as “unspent transactions,” due to there being currency sent to the address in a prior transaction where that currency is still unspent. In some cases, a blockchain transaction can also include the sender's public key, for use by an entity in validating the transaction. For the traditional processing of a blockchain transaction, such data can be provided to a blockchain node 112 in the blockchain network 110, either by the sender or the recipient. The node can verify the digital signature using the public key in the cryptographic key pair of the sender's wallet and also verify the sender's access to the funds (e.g., that the unspent transactions have not yet been spent and were sent to address associated with the sender's wallet), a process known as “confirmation” of a transaction, and then include the blockchain transaction in a new block. The new block can be validated by other blockchain nodes 112 in the blockchain network 110 before being added to the blockchain and distributed to all of the blockchain nodes 112 in the blockchain network 110, respectively, in traditional blockchain implementations. In cases where a blockchain data value cannot be related to a blockchain transaction, but instead the storage of other types of data, blockchain data values can still include or otherwise involve the validation of a digital signature.

In the system 100, each geographic location 108 can have a blockchain network 110, and thereby a blockchain, associated therewith. Each blockchain associated with a geographic location 108 can store transaction data for transactions involving a participant associated in the geographic location 108. During an onboarding process, the sender device 104 can register with the blockchain network 110a, via a blockchain node 112a or the processing server 102, to open a blockchain wallet for participating in blockchain transactions on the blockchain associated with the blockchain network 110a. In some cases, the sender device 104 can be required to provide information to illustrate the sender device's association with the geographic location 108a. Such information can include, for instance, proof of mailing address located in the geographic location 108a via an identification card, bank statement, utility bill, or other means such as server locations, internet traffic, database research, web-based identification tools, other registration data, Know Your Customer (KYC) techniques and services, etc. In some instances, the blockchain node 112a or processing server 102 can authenticate the provided information using suitable methods and systems.

As part of the onboarding process, a geographic key can be assigned to the sender device 104. The geographic key can be a unique identification value, such as an identification number, digital token, etc. that is associated with the geographic location 108a. The geographic key assigned to the sender device 104 can be the same geographic key assigned to any blockchain wallet associated with the geographic location 108a or can be a different geographic key that includes a common value across all keys assigned to blockchain wallets associated with the geographic location 108a. The blockchain node 112a or processing server 102, as applicable, can store a new blockchain data value on the blockchain associated with the geographic location 108a that includes the geographic key and data associated with the blockchain wallet of the sender device 104, such as the public key of the sender device's blockchain wallet.

After the sender device 104 has completed the onboarding process, the sender device 104 can participant in a blockchain transaction with other devices that have been onboarded with the blockchain networks 110. The sender device 104 can obtain a destination address from a recipient device 106 generated using the public key of the recipient device's blockchain wallet. The sender device 104 can identify one or more unspent addresses to which the sender device's blockchain wallet has received a suitable amount of cryptographic currency to satisfy the transaction and can generate a digital signature over the unspent transaction addresses using the sender device's private key.

A proposed blockchain transaction can be electronically transmitted to the processing server 102 via a suitable communication network and method, either directly from the sender device 104 or recipient device 106 or via one or more intermediary systems, such as via a blockchain node 112. The processing server 102 can receive the proposed blockchain transaction and can identify the geographic key associated with each of the devices participating in the proposed blockchain transaction using data included in the proposed blockchain transaction, such as the destination address, unspent transaction addresses, or public keys. The processing server 102 can identify the geographic keys and then determine if the geographic keys are the same or include a common identification value. If the geographic keys match, then the sender device 104 and recipient device 106 are determined to be located in the same geographic location 108a. The proposed blockchain transaction can then be transmitted to a blockchain node 112a in the blockchain network 110a associated with the geographic location 108a.

If the processing server 102 determines that the geographic keys do not match, then the processing server 102 has determined that the sender device 104 and recipient device 106 are located in different geographic locations 108. The processing server 102 can then input the geographic keys into a smart contract stored on a blockchain. The smart contract can be stored on the blockchain associated with the geographic location 108a of the sender device 104, the blockchain associated with the geographic location 108b of the recipient device 106b, or a core blockchain. A core blockchain can be associated with a blockchain network 110 that includes the blockchain nodes 112 of all of the participating blockchain networks 110a, 110b, etc. The core blockchain can be used to store geographic keys, smart contracts, and data regarding authorization of proposed blockchain transactions, as discussed below.

The processing server 102 can execute the smart contract using the geographic keys as input. The smart contract can be a self-executing program stored on the blockchain that accepts input, performs one or more functions utilizing the input, and outputs one or more values as a result of the executed functions. In the system 100, the smart contract can accept geographic keys as input and perform a validation process to determine if a blockchain transaction between the two associated geographic locations 108a and 108b is authorized. The determination can be based on, for instance, sanctions or regulations, such as can be received from one or more regulatory agencies 114, such as federal governments or agencies associated therewith, or can be received from participants in the blockchain networks 110. In an example, a governmental agency associated with the geographic location 108a can place sanctions on all transactions involving the geographic location 108b. In such cases, the smart contract can be configured to output a negative validation if provided geographic keys associated with both the geographic location 108a and geographic location 108b. The smart contract can output a positive validation if there are no restrictions placed on transactions between the geographic locations 108a and 108b.

The processing server 102 can execute the smart contract using the geographic keys as input and receive the validation result therefrom. If the validation is a negative validation, indicating that the blockchain transaction is not authorized, then the processing server 102 can decline the proposed blockchain transaction. In such a case, the processing server 102 can indicate to the sender device 104 or recipient device 106, either directly or via one or more intermediary systems (e.g., a blockchain node 112) that the transaction is declined and, in some instances, may include an indication that the transaction was declined due to one or more restrictions. If the validation is positive, then the processing server 102 can initiate processing of the blockchain transaction. The processing server 102 can electronically transmit the proposed blockchain transaction to blockchain nodes 112a and 112b associated with the blockchains of the geographic locations 108a and 108b. The blockchain nodes 112a and 112b can then perform traditional processing to determine if the blockchain transaction is approved and then, if approved, adding the blockchain transaction to the blockchain using traditional methods.

In some cases, a blockchain transaction stored on a blockchain associated with a geographic location 108 can only include data pertaining to blockchain wallets associated with that geographic location 108. For instance, in the above example, the blockchain associated with the geographic location 108a can store a blockchain transaction that indicates sending of cryptographic currency from the sender device's blockchain wallet (e.g., using the supplied unspent transaction outputs) out of the blockchain, while the blockchain associated with the geographic location 108b can store a blockchain transaction that indicates receipt of cryptographic currency to the recipient device's destination address from outside of the blockchain. In some embodiments, the full blockchain transaction or other data associated with the blockchain transaction can be stored in the core blockchain. In some cases, the core blockchain can be used to store all blockchain transaction data, while localized blockchains associated with the geographic locations 108 can be used to store geographic keys for the blockchain wallets associated with the respective geographic locations 108.

In some embodiments, the smart contract can be configured to initiate processing of the blockchain transaction if a positive validation result is determined. For instance, the smart contract can be configured to determine the validation result for authorization of the proposed blockchain transaction where, if a positive authorization is determined, the smart contract electronically transmits the relevant transaction data to blockchain nodes 112a and 112b, as identified using the supplied geographic keys.

The methods and systems discussed herein provide for the prevention of geographically unauthorized blockchain transactions. By associating sender devices 104 and recipient devices 106 with geographic locations 108 during onboarding, blockchain transactions across multiple geographic locations 108 that are restricted, such as due to sanctions, can be prevented. Because no data is retained about any of the participants, the anonymity of the blockchain wallets can be maintained while still preventing unauthorized transactions in particular exemplary implementations. As a result, the methods and systems discussed herein provide for a significant improvement over traditional blockchains without sacrificing the underlying benefits of using a blockchain for the transfer of cryptographic currency.

### Processing Server

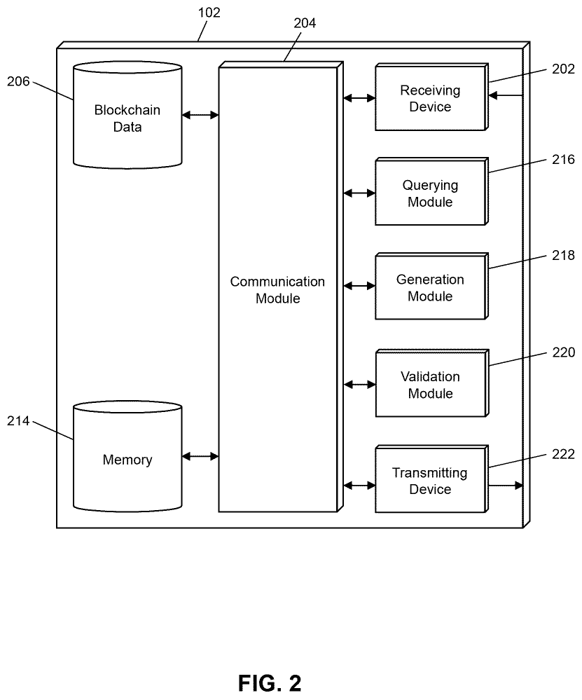

FIG. 2 illustrates an embodiment of a processing server 102. It will be apparent to persons having skill in the relevant art that the embodiment of the processing server 102 illustrated in FIG. 2 is provided as illustration only and cannot be exhaustive to all possible configurations of the processing server 102 suitable for performing the functions as discussed herein. For example, the computer system 500 illustrated in FIG. 5 and discussed in more detail below can be a suitable configuration of the processing server 102. In some cases, additional components of the system 100, such as the sender device 104, recipient device 106, blockchain nodes 112, and regulatory agency 114 can include the components illustrated in FIG. 2 and discussed below.

The processing server 102 can include a receiving device 202. The receiving device 202 can be configured to receive data over one or more networks via one or more network protocols. In some instances, the receiving device 202 can be configured to receive data from sender devices 104, recipient devices 106, blockchain nodes 112, regulatory agencies 114, and other systems and entities via one or more communication methods, such as radio frequency, local area networks, wireless area networks, cellular communication networks, Bluetooth, the Internet, etc. In some embodiments, the receiving device 202 can be comprised of multiple devices, such as different receiving devices for receiving data over different networks, such as a first receiving device for receiving data over a local area network and a second receiving device for receiving data via the Internet. The receiving device 202 can receive electronically transmitted data signals, where data can be superimposed or otherwise encoded on the data signal and decoded, parsed, read, or otherwise obtained via receipt of the data signal by the receiving device 202. In some instances, the receiving device 202 can include a parsing module for parsing the received data signal to obtain the data superimposed thereon. For example, the receiving device 202 can include a parser program configured to receive and transform the received data signal into usable input for the functions performed by the processing device to carry out the methods and systems described herein.

The receiving device 202 can be configured to receive data signals electronically transmitted by sender devices 104 and recipient devices 106 that are superimposed or otherwise encoded with onboarding data, such as geographic location identification data and cryptographic keys, proposed blockchain transactions, etc. The receiving device 202 can also be configured to receive data signals electronically transmitted by blockchain nodes 112, which can be superimposed or otherwise encoded with blockchain data values, cryptographic keys, smart contracts, blocks, proposed blockchain transaction data, geographic keys, etc. The receiving device 202 can also be configured to receive data signals electronically transmitted by regulatory agencies 114 that can be superimposed or otherwise encoded with data regarding restrictions, sanctions, or other limitations on blockchain transactions between geographic locations 108.

The processing server 102 can also include a communication module 204. The communication module 204 can be configured to transmit data between modules, engines, databases, memories, and other components of the processing server 102 for use in performing the functions discussed herein. The communication module 204 can be comprised of one or more communication types and utilize various communication methods for communications within a computing device. For example, the communication module 204 can be comprised of a bus, contact pin connectors, wires, etc. In some embodiments, the communication module 204 can also be configured to communicate between internal components of the processing server 102 and external components of the processing server 102, such as externally connected databases, display devices, input devices, etc. The processing server 102 can also include a processing device. The processing device can be configured to perform the functions of the processing server 102 discussed herein as will be apparent to persons having skill in the relevant art. In some embodiments, the processing device can include and/or be comprised of a plurality of engines and/or modules specially configured to perform one or more functions of the processing device, such as a querying module 216, generation module 218, validation module 220, etc. As used herein, the term “module” can be software or hardware particularly programmed to receive an input, perform one or more processes using the input, and provides an output. The input, output, and processes performed by various modules will be apparent to one skilled in the art based upon the present disclosure.

The processing server 102 can also include blockchain data 206, which can be stored in a memory 214 of the processing server 102 or stored in a separate area within the computing system 200 or accessible thereby. The blockchain data 206 can include a blockchain, which may be comprised of a plurality of blocks and be associated with the blockchain networks 110 and a core blockchain. In some cases, the blockchain data 206 can further include any other data associated with the blockchain and management and performance thereof, such as block generation algorithms, digital signature generation and confirmation algorithms, communication data for blockchain nodes 112, smart contracts, geographic keys, etc. The blockchain data 206 can also include data used by the processing server 102 for actions associated with a blockchain, such as cryptographic key pairs for blockchain wallets, public keys for generating destination addresses or validating digital signatures, transaction histories, cryptocurrency amounts, etc.

The processing server 102 can also include a memory 214. The memory 214 can be configured to store data for use by the processing server 102 in performing the functions discussed herein, such as public and private keys, symmetric keys, etc. The memory 214 can be configured to store data using suitable data formatting methods and schema and can be any suitable type of memory, such as read-only memory, random access memory, etc. The memory 214 can include, for example, encryption keys and algorithms, communication protocols and standards, data formatting standards and protocols, program code for modules and application programs of the processing device, and other data that can be suitable for use by the processing server 102 in the performance of the functions disclosed herein as will be apparent to persons having skill in the relevant art. In some embodiments, the memory 214 can be comprised of or can otherwise include a relational database that utilizes structured query language for the storage, identification, modifying, updating, accessing, etc. of structured data sets stored therein. The memory 214 can be configured to store, for example, cryptographic keys, cryptographic key pairs, cryptographic algorithms, encryption algorithms, communication information, data formatting rules, network identifiers, geographic keys, smart contracts, etc.

The processing server 102 can include a querying module 216. The querying module 216 can be configured to execute queries on databases to identify information. The querying module 216 can receive one or more data values or query strings and can execute a query string based thereon on an indicated database, such as the entity database 206 of the processing server 102 to identify information stored therein. The querying module 216 can then output the identified information to an appropriate engine or module of the processing server 102 as necessary. The querying module 216 can, for example, execute a query on the blockchain data to identify blockchain data values that include data associated with blockchain wallets included in a received proposed blockchain transaction for the identification of geographic keys stored therein.

The processing server 102 can also include a generation module 218. The generation module 218 can be configured to generate data for use by the processing server 102 in performing the functions discussed herein. The generation module 218 can receive instructions as input, can generate data based on the instructions, and can output the generated data to one or more modules of the processing server 102. For example, the generation module 218 can be configured to generate data messages, notification messages, cryptographic keys, blockchain transactions, blockchain data values, smart contracts, etc.

The processing server 102 can also include a validation module 220. The validation module 220 can be configured to perform validations for the processing server 102 as part of the functions discussed herein. The validation module 220 can receive instructions as input, which can also include data to be used in performing a validation, can perform a validation as requested, and can output a result of the validation to another module or engine of the processing server 102. The validation module 220 can, for example, be configured to validate blockchain transactions that include blockchain wallets associated with multiple geographic locations 108 using geographic keys as input and based on included restriction and limitation data and to output a positive or negative validation result.

The processing server 102 can also include a transmitting device 222. The transmitting device 222 can be configured to transmit data over one or more networks via one or more network protocols. In some instances, the transmitting device 222 can be configured to transmit data sender devices 104, recipient devices 106, blockchain nodes 112, regulatory agencies 114, and other entities via one or more communication methods, local area networks, wireless area networks, cellular communication, Bluetooth, radio frequency, the Internet, etc. In some embodiments, the transmitting device 222 can be comprised of multiple devices, such as different transmitting devices for transmitting data over different networks, such as a first transmitting device for transmitting data over a local area network and a second transmitting device for transmitting data via the Internet. The transmitting device 222 can electronically transmit data signals that have data superimposed that can be parsed by a receiving computing device. In some instances, the transmitting device 222 can include one or more modules for superimposing, encoding, or otherwise formatting data into data signals suitable for transmission.

The transmitting device 222 can be configured to electronically transmit data signals to sender devices 104 and recipient devices 106 that can be superimposed or otherwise encoded with data requests, notification messages, geographic keys, etc. The transmitting device 222 can also be configured to electronically transmit data signals to blockchain nodes 112, which can be superimposed or otherwise encoded with blockchain wallet identification data, geographic key requests, proposed blockchain transaction data, smart contracts, geographic key input data, etc. The transmitting device 222 can also be configured to electronically transmit data signals to regulatory agencies 114 that can be superimposed or otherwise encoded with requests for restriction and limitation data.

### Process for Preventing Geographically Unauthorized Transactions

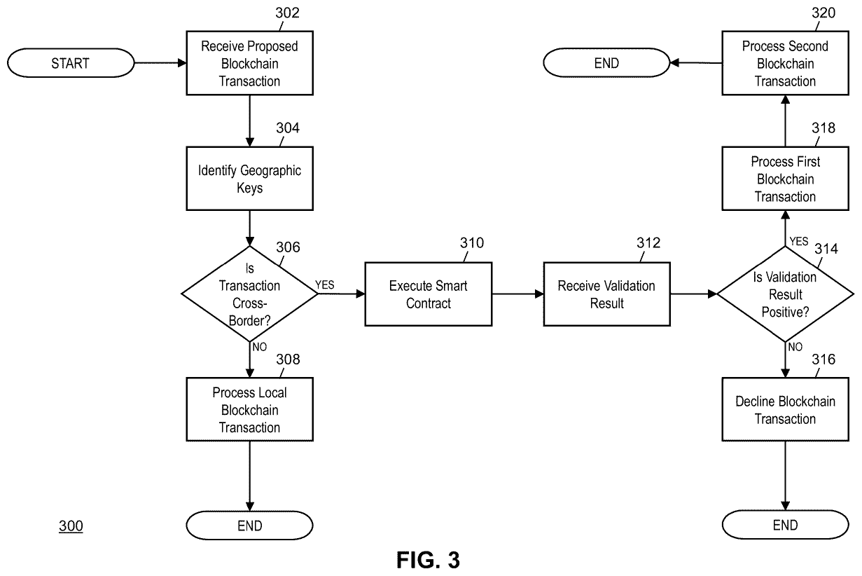

FIG. 3 illustrates a process 300 for the preventing of geographically unauthorized blockchain transactions involving participants in multiple geographic locations 108 as performed by the processing server 102 in the system 100 of FIG. 1.

In step 302, the receiving device 202 of the processing server 102 can receive a proposed blockchain transaction from a sender device 104, recipient device 106, or blockchain node 112 that includes one or more unspent transaction outputs, also referred to herein as a source address, a digital signature, destination address, and cryptographic currency amount. The proposed blockchain transaction can also include public keys or other data used in the identification of blockchain wallets involved in the proposed blockchain transaction. In step 304, the processing server 102 can identify a geographic key associated with each of the blockchain wallets involved in the proposed blockchain transaction, such as by executing, via the querying module 216, a query on the blockchain data 206 of the processing server 102 to identify a blockchain data value that includes the identification data of the respective blockchain wallet, or by transmitting, via the transmitting device 222, a data request to a blockchain node 112 that includes the identification data for the blockchain wallets. In step 306, the processing server 102 can determine if the proposed blockchain transaction is a cross-border transaction, such as by checking if the geographic keys for the two blockchain wallets match or otherwise include common identification values. If the processing server 102 determines that the proposed blockchain transaction is not cross-border, then, in step 308, the processing server 102 can process the local blockchain transaction, such as by electronically transmitting the proposed blockchain transaction to a blockchain node 112 in the geographic location 108 associated with the identified geographic keys, which can then approve and add the blockchain transaction to the associated blockchain using traditional methods and systems.

If the processing server 102 determines that the proposed blockchain transaction is a cross-border transaction, then, in step 310, the processing server 102 can execute a smart contract stored in the core blockchain or a blockchain associated with one of the geographic locations 108 associated with the identified geographic keys, where the identified geographic keys are used as input for the smart contract. The smart contract can execute and perform a validation using the supplied geographic keys and output a validation result. In step 312, the receiving device 202 can receive the validation result output by the smart contract. In step 314, the processing server 102 can determine if the validation result from the smart contract is a positive result. If the validation result is not positive, then, in step 316, the processing server 102 can decline the blockchain transaction, such as by transmitting, via the transmitting device 222, a notification message to the sender device 104, recipient device 106, or blockchain node 112, as applicable, indicating decline of the blockchain transaction. In some cases, a reason can be provided for the decline, such as an indication of decline due to restriction on transactions between the geographic locations 108.

If the validation result is positive, then, in step 318, the processing server 102 can process the first blockchain transaction for addition thereto in the blockchain associated with the first geographic location 108a, such as by electronically transmitting the proposed blockchain transaction to a blockchain node 112a in the first geographic location 108a, which can then approve and add the blockchain transaction to the associated blockchain using traditional methods and systems. In step 320, the processing server 102 can process the second blockchain transaction for addition thereto in the blockchain associated with the second geographic location 108b, such as by electronically transmitting the proposed blockchain transaction to a blockchain node 112b in the second geographic location 108b, which can then approve and add the blockchain transaction to the associated blockchain using traditional methods and systems.

### Exemplary Method for Preventing Unauthorized Blockchain Transactions

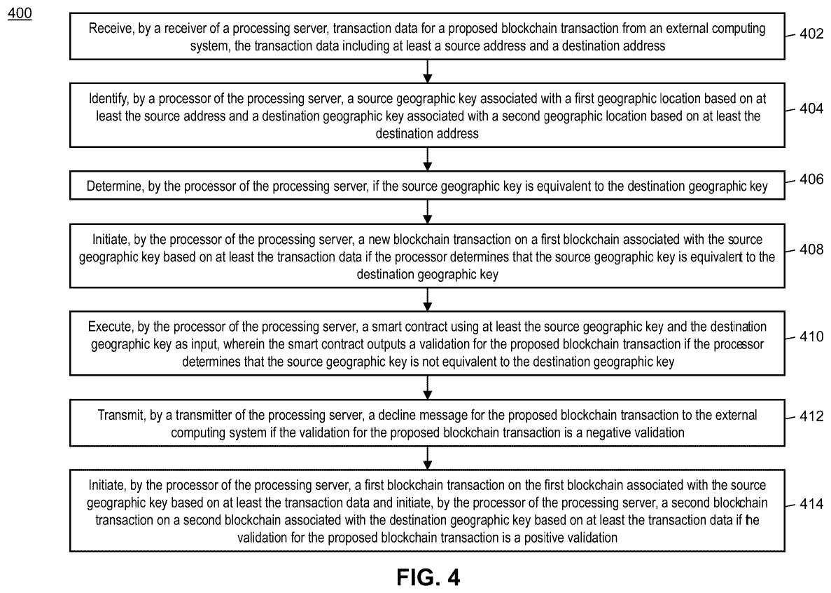

FIG. 4 illustrates a method 400 for the prevention of blockchain transactions that are unauthorized due to different geographic locations of participants.

In step 402, a receiver (e.g., receiving device 202) of a processing server (e.g., processing server 102) can receive transaction data for a proposed blockchain transaction from an external computing system (e.g., sender device 104, recipient device 106, blockchain node 112, etc.), the transaction data including at least a source address and a destination address. In step 404, a processor (e.g., querying module 216) of the processing server can identify a source geographic key associated with a first geographic location based on at least the source address and a destination geographic key associated with a second geographic location based on at least the destination address. In step 406, the processor (e.g., validation module 220) of the processing server can determine if the source geographic key is equivalent to the destination geographic key.

In step 408, the processor (e.g., generation module 218, transmitting device 222, etc.) of the processing server can initiate a new blockchain transaction on a first blockchain associated with the source geographic key based on at least the transaction data if the processor determines that the source geographic key is equivalent to the destination geographic key. In step 410, the processor (e.g., querying module 214, transmitting device 222, etc.) of the processing server can execute a smart contract using at least the source geographic key and the destination geographic key as input, wherein the smart contract outputs a validation for the proposed blockchain transaction if the processor determines that the source geographic key is not equivalent to the destination geographic key.

In step 412, a transmitter (e.g., transmitting device 222) of the processing server can transmit a decline message for the proposed blockchain transaction to the external computing system if the validation for the proposed blockchain transaction is a negative validation. In step 414, the processor (e.g., generation module 218, transmitting device 222, etc.) of the processing server can initiate a first blockchain transaction on the first blockchain associated with the source geographic key based on at least the transaction data and initiate, by the processor (e.g., generation module 218, transmitting device 222, etc.) of the processing server, a second blockchain transaction on a second blockchain associated with the destination geographic key based on at least the transaction data if the validation for the proposed blockchain transaction is a positive validation.

In one embodiment, the method 400 can further include initiating, by the processor (e.g., generation module 218, transmitting device 222, etc.) of the processing server, a third blockchain transaction on a core blockchain based on at least the transaction data. In a further embodiment, the smart contract can be stored in a block in the core blockchain. In some embodiments, the smart contract can be stored in a block in the first blockchain associated with the source geographic key. In one embodiment, the smart contract can be stored in a block in the second blockchain associated with the destination geographic key.

In some embodiments, the validation for the proposed blockchain transaction can be based on one or more sanctions restricting transactions between different geographic locations. In a further embodiment, the one or more sanctions can be imposed by at least one governmental agency. In one embodiment, the first blockchain transaction can indicate transfer of a first amount of blockchain currency associated with the first blockchain out of the first blockchain, and the second blockchain transaction can indicate transfer of a second amount of blockchain currency associated with the second blockchain in to the second blockchain.

### Computer System Architecture

FIG. 5 illustrates a computer system 500 in which embodiments of the present disclosure, or portions thereof, can be implemented as computer-readable code. For example, the processing server 102, sender device 104, recipient devices 106, blockchain nodes 112, and regulatory agency 114 can be implemented in the computer system 500 using hardware, non-transitory computer readable media having instructions stored thereon, or a combination thereof and can be implemented in one or more computer systems or other processing systems. Hardware can embody modules and components used to implement the methods of FIGS. 3 and 4.

If programmable logic is used, such logic can execute on a commercially available processing platform configured by executable software code to become a specific purpose computer or a special purpose device (e.g., programmable logic array, application-specific integrated circuit, etc.). A person having ordinary skill in the art can appreciate that embodiments of the disclosed subject matter can be practiced with various computer system configurations, including multi-core multiprocessor systems, minicomputers, mainframe computers, computers linked or clustered with distributed functions, as well as pervasive or miniature computers that can be embedded into virtually any device. For instance, at least one processor device and a memory can be used to implement the above-described embodiments.

A processor unit or device as discussed herein can be a single processor, a plurality of processors, or combinations thereof. Processor devices can have one or more processor “cores.” The terms “computer program medium,” “non-transitory computer readable medium,” and “computer usable medium” as discussed herein are used to generally refer to tangible media such as a removable storage unit 518, a removable storage unit 522, and a hard disk installed in hard disk drive 512.

Various embodiments of the present disclosure are described in terms of this example computer system 500. After reading this description, it will become apparent to a person skilled in the relevant art how to implement the present disclosure using other computer systems and/or computer architectures. Although operations can be described as a sequential process, some of the operations can in fact be performed in parallel, concurrently, and/or in a distributed environment, and with program code stored locally or remotely for access by single or multi-processor machines. In addition, in some embodiments the order of operations can be rearranged without departing from the spirit of the disclosed subject matter.

Processor device 504 can be a special purpose or a general purpose processor device specifically configured to perform the functions discussed herein. The processor device 504 can be connected to a communications infrastructure 506, such as a bus, message queue, network, multi-core message-passing scheme, etc. The network can be any network suitable for performing the functions as disclosed herein and can include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 500 can also include a main memory 508 (e.g., random access memory, read-only memory, etc.), and can also include a secondary memory 510. The secondary memory 510 can include the hard disk drive 512 and a removable storage drive 514, such as a floppy disk drive, a magnetic tape drive, an optical disk drive, a flash memory, etc.

The removable storage drive 514 can read from and/or write to the removable storage unit 518 in a well-known manner. The removable storage unit 518 can include a removable storage media that can be read by and written to by the removable storage drive 514. For example, if the removable storage drive 514 is a floppy disk drive or universal serial bus port, the removable storage unit 518 can be a floppy disk or portable flash drive, respectively. In one embodiment, the removable storage unit 518 can be non-transitory computer readable recording media.

In some embodiments, the secondary memory 510 can include alternative means for allowing computer programs or other instructions to be loaded into the computer system 500, for example, the removable storage unit 522 and an interface 520. Examples of such means can include a program cartridge and cartridge interface (e.g., as found in video game systems), a removable memory chip (e.g., EEPROM, PROM, etc.) and associated socket, and other removable storage units 522 and interfaces 520 as will be apparent to persons having skill in the relevant art.

Data stored in the computer system 500 (e.g., in the main memory 508 and/or the secondary memory 510) can be stored on any type of suitable computer readable media, such as optical storage (e.g., a compact disc, digital versatile disc, Blu-ray disc, etc.) or magnetic tape storage (e.g., a hard disk drive). The data can be configured in any type of suitable database configuration, such as a relational database, a structured query language (SQL) database, a distributed database, an object database, etc. Suitable configurations and storage types will be apparent to persons having skill in the relevant art.

The computer system 500 can also include a communications interface 524. The communications interface 524 can be configured to allow software and data to be transferred between the computer system 500 and external devices. Exemplary communications interfaces 524 can include a modem, a network interface (e.g., an Ethernet card), a communications port, a PCMCIA slot and card, etc. Software and data transferred via the communications interface 524 can be in the form of signals, which can be electronic, electromagnetic, optical, or other signals as will be apparent to persons having skill in the relevant art. The signals can travel via a communications path 526, which can be configured to carry the signals and can be implemented using wire, cable, fiber optics, a phone line, a cellular phone link, a radio frequency link, etc.

The computer system 500 can further include a display interface 502. The display interface 502 can be configured to allow data to be transferred between the computer system 500 and external display 530. Exemplary display interfaces 502 can include high-definition multimedia interface (HDMI), digital visual interface (DVI), video graphics array (VGA), etc. The display 530 can be any suitable type of display for displaying data transmitted via the display interface 502 of the computer system 500, including a cathode ray tube (CRT) display, liquid crystal display (LCD), light-emitting diode (LED) display, capacitive touch display, thin-film transistor (TFT) display, etc.

Computer program medium and computer usable medium can refer to memories, such as the main memory 508 and secondary memory 510, which can be memory semiconductors (e.g., DRAMs, etc.). These computer program products can be means for providing software to the computer system 500. Computer programs (e.g., computer control logic) can be stored in the main memory 508 and/or the secondary memory 510. Computer programs can also be received via the communications interface 524. Such computer programs, when executed, can enable computer system 500 to implement the present methods as discussed herein. In particular, the computer programs, when executed, can enable processor device 504 to implement the methods illustrated by FIGS. 3 and 4, as discussed herein. Accordingly, such computer programs can represent controllers of the computer system 500. Where the present disclosure is implemented using software, the software can be stored in a computer program product and loaded into the computer system 500 using the removable storage drive 514, interface 520, and hard disk drive 512, or communications interface 524.

The processor device 504 can comprise one or more modules or engines configured to perform the functions of the computer system 500. Each of the modules or engines can be implemented using hardware and, in some instances, can also utilize software, such as corresponding to program code and/or programs stored in the main memory 508 or secondary memory 510. In such instances, program code can be compiled by the processor device 504 (e.g., by a compiling module or engine) prior to execution by the hardware of the computer system 500. For example, the program code can be source code written in a programming language that is translated into a lower-level language, such as assembly language or machine code, for execution by the processor device 504 and/or any additional hardware components of the computer system 500. The process of compiling can include the use of lexical analysis, preprocessing, parsing, semantic analysis, syntax-directed translation, code generation, code optimization, and any other techniques that can be suitable for translation of program code into a lower-level language suitable for controlling the computer system 500 to perform the functions disclosed herein. It will be apparent to persons having skill in the relevant art that such processes result in the computer system 500 being a specially configured computer system 500 uniquely programmed to perform the functions discussed above.

Techniques consistent with the present disclosure provide, among other features, systems and methods for preventing geographically unauthorized blockchain transactions. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or can be acquired from practicing of the disclosure, without departing from the breadth or scope.

We claim:

1. A method for preventing geographically unauthorized blockchain transactions, comprising:
receiving, by a receiver of a processing server, transaction data for a proposed blockchain transaction from an external computing system, the transaction data including at least a source address and a destination address;
identifying, by a processor of the processing server, a source geographic key associated with a first geographic location based on at least the source address and a destination geographic key associated with a second geographic location based on at least the destination address;
determining, by the processor of the processing server, if the source geographic key is equivalent to the destination geographic key;
if the processor determines that the source geographic key is equivalent to the destination geographic key, initiating, by the processor of the processing server, a new blockchain transaction on a first blockchain associated with the source geographic key based on at least the transaction data;
if the processor determines that the source geographic key is not equivalent to the destination geographic key, executing, by the processor of the processing server, a smart contract using at least the source geographic key and the destination geographic key as input, wherein the smart contract outputs a validation for the proposed blockchain transaction;
if the validation for the proposed blockchain transaction is a negative validation, transmitting, by a transmitter of the processing server, a decline message for the proposed blockchain transaction to the external computing system; and
if the validation for the proposed blockchain transaction is a positive validation,
initiating, by the processor of the processing server, a first blockchain transaction on the first blockchain associated with the source geographic key based on at least the transaction data, and
initiating, by the processor of the processing server, a second blockchain transaction on a second blockchain associated with the destination geographic key based on at least the transaction data.

2. The method of claim 1, further comprising:
initiating, by the processor of the processing server, a third blockchain transaction on a core blockchain based on at least the transaction data.

3. The method of claim 2, wherein the smart contract is stored in a block in the core blockchain.

4. The method of claim 1, wherein the smart contract is stored in a block in the first blockchain associated with the source geographic key.

5. The method of claim 1, wherein the smart contract is stored in a block in the second blockchain associated with the destination geographic key.

6. The method of claim 1, wherein the validation for the proposed blockchain transaction is based on one or more sanctions restricting transactions between different geographic locations.

7. The method of claim 6, wherein the one or more sanctions are imposed by at least one governmental agency.

8. The method of claim 1, wherein
the first blockchain transaction indicates transfer of a first amount of blockchain currency associated with the first blockchain out of the first blockchain, and
the second blockchain transaction indicates transfer of a second amount of blockchain currency associated with the second blockchain in to the second blockchain.

9. A system for preventing geographically unauthorized blockchain transactions, comprising:
an external computing system; and
a processing server, the processing server including
a receiver receiving transaction data for a proposed blockchain transaction from the external computing system, the transaction data including at least a source address and a destination address,
a processor, the processor
identifying a source geographic key associated with a first geographic location based on at least the source address and a destination geographic key associated with a second geographic location based on at least the destination address, and
determining if the source geographic key is equivalent to the destination geographic key, and
a transmitter, wherein
if the processor of the processing server determines that the source geographic key is equivalent to the destination geographic key, initiating, by the processor of the processing server, a new blockchain transaction on a first blockchain associated with the source geographic key based on at least the transaction data,
if the processor determines that the source geographic key is not equivalent to the destination geographic key, the processor of the processing server executes a smart contract using at least the source geographic key and the destination geographic key as input, wherein the smart contract outputs a validation for the proposed blockchain transaction;
if the validation for the proposed blockchain transaction is a negative validation, the transmitter of the processing server transmits a decline message for the proposed blockchain transaction to the external computing system, and
if the validation for the proposed blockchain transaction is a positive validation,
the processor of the processing server initiates a first blockchain transaction on the first blockchain associated with the source geographic key based on at least the transaction data, and
the processor of the processing server initiates a second blockchain transaction on a second blockchain associated with the destination geographic key based on at least the transaction data.

10. The system of claim 9, wherein the processor of the processing server further initiates a third blockchain transaction on a core blockchain based on at least the transaction data.

11. The system of claim 10, wherein the smart contract is stored in a block in the core blockchain.

12. The system of claim 9, wherein the smart contract is stored in a block in the first blockchain associated with the source geographic key.

13. The system of claim 9, wherein the smart contract is stored in a block in the second blockchain associated with the destination geographic key.

14. The system of claim 9, wherein the validation for the proposed blockchain transaction is based on one or more sanctions restricting transactions between different geographic locations.

15. The system of claim 14, wherein the one or more sanctions are imposed by at least one governmental agency.

16. The system of claim 9, wherein
the first blockchain transaction indicates transfer of a first amount of blockchain currency associated with the first blockchain out of the first blockchain, and
the second blockchain transaction indicates transfer of a second amount of blockchain currency associated with the second blockchain in to the second blockchain.
